(19) United States
(12) Patent Application Publication
(10) Pub. No.: US 2026/0321860 A1
(43) Pub. Date: Oct. 15, 2026

(54) BATTERY ASSEMBLY

(71) Applicant: SK On Co., Ltd., Seoul (KR)

(72) Inventors: Dae Hyeon LEE, Daejeon (KR); Yong Hee JANG, Daejeon (KR)

(21) Appl. No.: 19/467,804

(22) Filed: Feb. 3, 2026

(30) Foreign Application Priority Data
Feb. 3, 2025 (KR) 10-2025-0013189

(51) Int. Cl. H01M 50/291; H01M 10/658; H01M 50/244; H01M 50/271; H01M 50/367; H01M 50/507; H01M 50/204

(52) U.S. Cl. CPC H01M 50/291; H01M 10/658; H01M 50/244; H01M 50/271; H01M 50/367; H01M 50/507; H01M 50/204

(57) ABSTRACT

The present disclosure relates to a battery assembly. The battery assembly according to an embodiment of this disclosure may comprise: battery cells arranged along a stacking direction; and a housing case receiving the battery cells and including an end plate positioned adjacent to tab portions of the battery cells; wherein the end plate may comprise: a support body positioned outside the battery cells and extending along the stacking direction; and a first support wall protruding from a surface of the support body toward the battery cells and partitioning a space between the battery cells and the support body.

### CROSS-REFERENCE TO RELATED PATENT APPLICATION

The present application claims priority under 35 U.S.C. § 119a to Korean patent applications number 10-2025-0013189 filed on Feb. 3, 2025 in the Ministry of Intellectual Property in Korea, the entire disclosures of which are incorporated by reference herein.

### BACKGROUND OF THE DISCLOSURE

### FIELD

This disclosure relates to a battery assembly.

### DESCRIPTION OF THE RELATED ART

Secondary batteries are rechargeable batteries that can be charged and discharged. They can be applied to a wide range of mobility devices, such as portable electronic devices, automobiles, ships, aircraft, and drones. Secondary batteries can be utilized as battery assemblies, which electrically connect multiple battery cells to increase battery capacity or output. Battery assemblies can be categorized as battery modules or battery packs, depending on the unit.

Battery modules, due to their structure containing multiple battery cells, face the problem that heat or gas from a specific battery cell can easily propagate to adjacent cells. Consequently, measures to enhance the stability of battery modules are required.

According to one aspect of the present disclosure, a battery assembly is provided with improved thermal stability by safely venting flames or gases in a safe direction.

According to another aspect of the present disclosure, a battery assembly is provided that extends battery life by reducing thermal propagation.

Meanwhile, this disclosure can be widely applied in the fields of electric vehicles, battery charging stations, energy storage systems, and other green technologies utilizing batteries, such as photovoltaics and wind power.

Furthermore, this disclosure can be used in eco-friendly mobility, including electric vehicles and hybrid vehicles, to prevent climate change by suppressing air pollution and greenhouse gas emissions.

### SUMMARY OF THE DISCLOSURE

A battery assembly according to an embodiment of this disclosure may comprise: battery cells arranged along a stacking direction; and a housing case receiving the battery cells and including an end plate positioned adjacent to tab portions of the battery cells; wherein the end plate may comprise: a support body positioned outside the battery cells and extending along the stacking direction; and a first support wall protruding from a surface of the support body toward the battery cells and partitioning a space between the battery cells and the support body.

In an embodiment, the battery assembly further may comprise: a busbar assembly positioned between the end plate and the battery cells and electrically connecting the battery cells, wherein the first support wall may contact the busbar assembly.

In an embodiment, the first support wall may be provided in a plurality, and wherein the plurality of first support walls may be arranged at predetermined intervals along the stacking direction.

In an embodiment, the end plate may further include a second support wall protruding from another surface of the support body in a direction away from the battery cells.

In an embodiment, the first support wall and the second support wall may be positioned correspondingly with respect to the support body.

In an embodiment, the first support wall and the second support wall may be each provided in a plurality, and the plurality of first support walls and the plurality of second support walls may be positioned corresponding to each other with respect to the support body.

In an embodiment, a protrusion length of the first support wall may be equal to or greater than a protrusion length of the second support wall.

In an embodiment, the first support wall and the second support wall may be each tapered as they move away from the support body.

In an embodiment, a height of the first support wall may be equal to or greater than a height of the battery cells.

In an embodiment, a height of the second support wall may be equal to or greater than a height of the battery cells.

In an embodiment, the battery assembly may further comprise: a thermal barrier member disposed between the battery cells along the stacking direction, wherein the first support wall may be positioned in correspondence with the thermal barrier member along the stacking direction.

In an embodiment, the first support wall and the thermal barrier member may be each provided in a plurality, and the plurality of first support walls may be positioned in correspondence with the plurality of thermal barrier members along the stacking direction.

In an embodiment, the housing case may include a housing body forming a receiving space for receiving the battery cells, and the housing body may include grooves arranged at predetermined intervals along the stacking direction.

In an embodiment, wherein the thermal barrier is provided in a plurality, and each of the plurality of thermal barrier members is inserted into a corresponding one of the grooves.

In an embodiment, the housing case may include a housing cover coupled to the housing body to form the receiving space together, and the housing cover may include a venting hole penetrating the housing cover.

In an embodiment, wherein the venting hole and the thermal barrier are provided in a plurality, wherein each of the plurality of venting holes are located between each of the plurality of thermal barrier members.

In an embodiment, the thermal barrier member may protrude toward the housing cover beyond the battery cells.

In an embodiment, the thermal barrier member may contact the housing cover.

A battery assembly according to another embodiment of this disclosure may comprise: battery cells each including an electrode assembly, a cell case accommodating the electrode assembly, and a tab protruding from the cell case and electrically connected to the electrode assembly; a housing case forming a receiving space for receiving the battery cells arranged along a predetermined stacking direction, and including an opening formed between the battery cells along a direction in which the tab protrudes; and an end plate coupled to the housing case and covering the opening; wherein the end plate may partition the receiving space between the battery cells.

According to an embodiment of the present disclosure, the flames or gases can be safely vented in a safe direction, thereby improving the thermal stability of the battery assembly.

According to another embodiment of the present disclosure, the thermal propagation can be reduced, thereby improving the battery life of the battery assembly.

### BRIEF DESCRIPTION OF THE DRAWINGS

FIG. 1 is a diagram showing a battery assembly according to embodiments of the present disclosure.

FIG. 2 is an exploded view illustrating the battery assembly according to embodiments of the present disclosure.

FIG. 3 is a perspective view illustrating the battery cells and thermal barrier members of the battery assembly shown in FIG. 2.

FIGS. 4 and 5 are drawings illustrating the end plate of the battery assembly shown in FIG. 2.

FIG. 6 is a drawing illustrating the effect based on the structure of the end plate in FIG. 2.

FIG. 7 is an enlarged view of the X portion of FIG. 2.

FIGS. 8 and 9 are drawings illustrating the effects of the structure of the housing body in FIG. 2.

### DETAILED DESCRIPTION

The following describes in detail a preferred embodiment of the present disclosure with reference to the accompanying drawings. The configuration of the device and the control method described below are intended only to explain the embodiment of the present disclosure and are not intended to limit the scope of the present disclosure. Reference numbers used throughout the specification denote the same components.

Meanwhile, the battery assembly according to this disclosure is a concept that collectively refers to a battery module, a battery pack, and an energy storage system. The battery module refers to a battery assembly where a plurality of battery cells are grouped together in one or more quantities to protect them from external impacts, heat, vibration, etc., and then enclosed in a case. The battery pack refers to a battery assembly that ultimately accommodates a predetermined number of such battery modules to achieve the desired voltage or power.

Furthermore, the battery assembly according to this disclosure may also refer to a battery pack with a Cell to Pack (CTP) structure, which generates the desired voltage or power by accommodating a predetermined number of battery cells without the battery module.

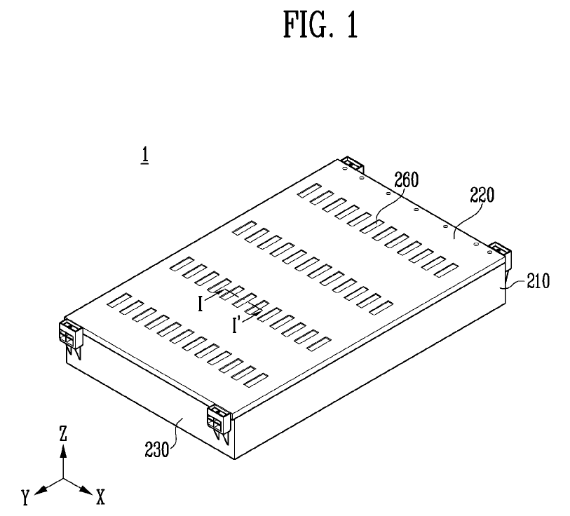

FIG. 1 is a diagram showing a battery assembly according to embodiments of the present disclosure.

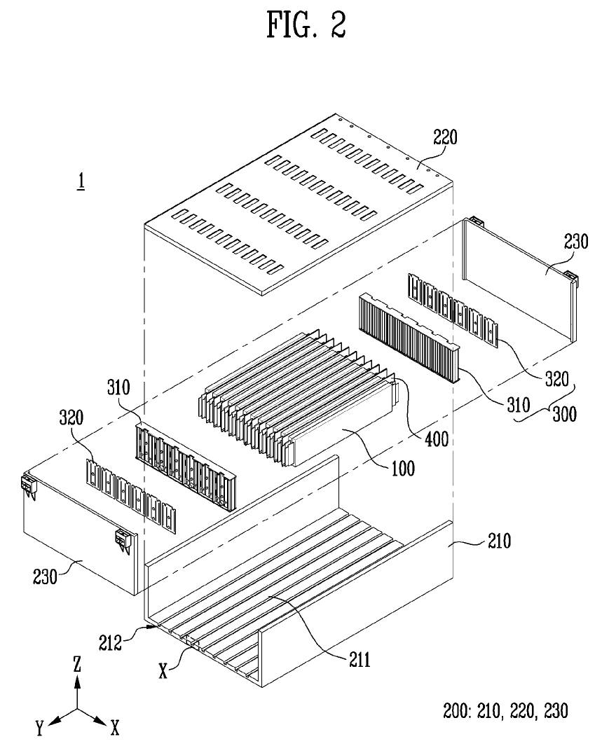

Referring to FIG. 1, the battery assembly 1 according to the present disclosure may include a housing case 200 receiving battery cells 100, referring to FIG. 2, arranged along a stacking direction and an end plate 230 positioned adjacent to the tabs of the battery cells 100. The housing case 200 may further include, in addition to the end plate 230, a housing body 210 and a housing cover 220. The housing cover 220 may include a venting hole 260.

The housing body 210, housing cover 220, and end plate 230 can be coupled together. The housing body 210, housing cover 220, and end plate 230 can be combined to form a receiving space. The housing body 210, housing cover 220, and end plate 230 can protect the plurality of battery cells 100 received within the receiving space from external impacts or foreign objects. The material of each of the housing body 210, housing cover 220, and end plate 230 may include any one of aluminum, iron, or polymer. However, the embodiments of the present disclosure are not necessarily limited thereto.

The housing cover 220 may include a venting hole 260 formed through the housing cover 220. Depending on the embodiment, the venting hole 260 may be provided in a plurality. Referring to FIG. 1, the venting hole 260 is shown as formed by penetrating the housing cover 220, but the embodiments of the present disclosure are not necessarily limited thereto.

For example, the venting hole 260 may be located on the end plate 230 or on the housing body 210. As long as gas and smoke generated from thermally runaway battery cells 100 can be smoothly discharged through the venting hole 260, the venting hole 260 may be located anywhere. However, to minimize or delay thermal propagation to other battery cells 100 caused by the thermally runaway battery cells 100, it is desirable for the gas and smoke generated from the thermally runaway battery cells 100 to be discharged through the housing cover 220 along the height direction of the housing body 210. For this purpose, the housing cover 220 may include the venting hole 260 penetrating the housing cover 220.

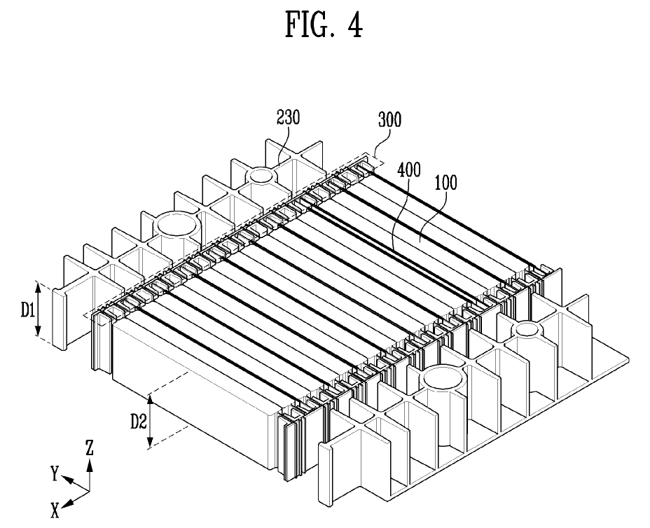

In FIGS. 1 and 2, the end plate 230 is shown schematically for ease of description. The specific configuration of the end plate 230 is described in detail in FIG. 4.

FIG. 2 is an exploded view illustrating the battery assembly according to embodiments of the present disclosure.

Referring to FIG. 2, the battery assembly 1 according to the present disclosure may include a plurality of battery cells 100, a housing case 200, a busbar assembly 300, and a thermal barrier member 400.

The housing case 200 may include a housing body 210, a housing cover 220, and an end plate 230.

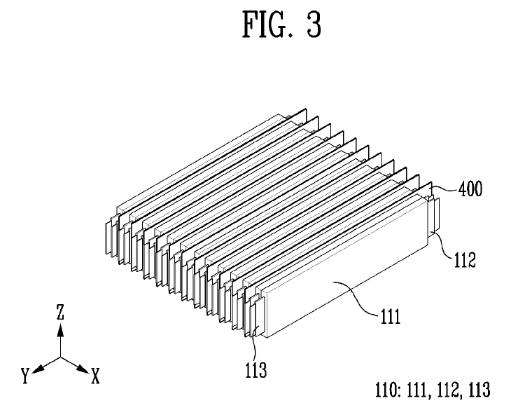

A battery cell 110 may include a cell case 111, referring to FIG. 3, for producing or storing electrical energy, and tabs 112, 113 protruding outwardly from the cell case.

The cell case 111 accommodates an electrode assembly internally including a positive electrode and a negative electrode for producing and storing electrical energy, and the tabs 112, 113 may be electrically connected to the electrode assembly.

The plurality of battery cells 100 may be various types of secondary batteries, such as lithium-ion batteries, vanadium-ion batteries, all-solid-state batteries, metal-air batteries, sodium-ion batteries, and aluminum-ion batteries.

The plurality of battery cells 100 may be arranged along a stacking direction or a first direction X. The plurality of battery cells 100 may be positioned at predetermined intervals along the first direction X. The plurality of battery cells 100 may produce or store electrical energy.

A thermal barrier member 400 may be disposed between the battery cells 100 along the stacking direction or first direction X. Depending on the embodiment, the thermal barrier member 400 may be provided in a plurality. This will be described later with reference to FIG. 3.

The plurality of battery cells 100 can be received inside the receiving space formed by combining the housing body 210, housing cover 220, and end plate 230. The housing body 210 and housing cover 220 may be connected to form a hexahedral shape with an open front and rear. Here, the "front" may refer to the surface facing forward along the Y-axis direction, and the "rear" may refer to the surface facing backward along the opposite direction of the Y-axis. The housing body 210, housing cover 220, and end plate 230 can prevent damage to the plurality of battery cells 100 from external impacts, heat, vibration, or pressure.

The housing body 210 may include an opening 211 open toward the top surface. In an embodiment, the housing body 210 may include an opening 211 open in a second direction Y. Through the opening 211, the plurality of battery cells 100 can be placed on the housing body 210. The housing body 210 may include a side body formed with edges extending toward the top surface to cover the plurality of battery cells 100. In an embodiment, the housing body 210 may have a "U" shape.

The housing body 210 may overlap at least a portion of the plurality of battery cells 100. For example, the housing body 210 may overlap a portion of the plurality of battery cells 100 in a third direction Z. The housing body 210 may be positioned beneath the plurality of battery cells 100. The housing body 210 may support the plurality of battery cells 100.

One surface of the housing body 210 e.g., the bottom surface of the housing body 210 may include a groove 212. The groove 212 may extend lengthwise in a second direction Y. Depending on the embodiment, the groove 212 may be provided in a plurality, and the plurality of grooves may be arranged at predetermined intervals along the stacking direction or first direction X of the battery cells 100.

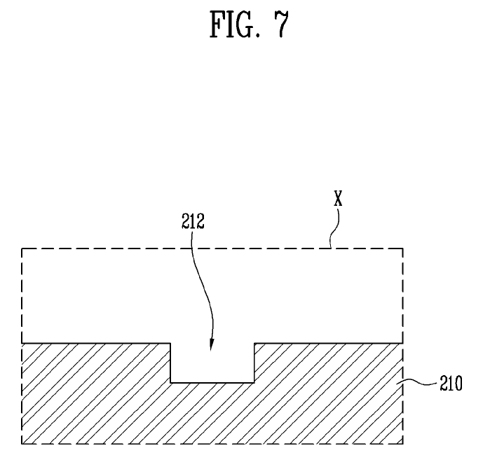

The thermal barrier member 400 can be inserted into the groove 212. For this purpose, the number of grooves 212 can be equal to the number of thermal barrier members 400. When the thermal barrier member 400 is fitted into the groove 212, it can effectively block the movement of substances such as flames or smoke between adjacent battery cells, with the thermal barrier member 400 serving as the boundary. This is described in detail later with reference to FIGS. 7 through 9.

The housing body 210 may have a high thermal conductivity characteristic. For example, the housing body 210 may include a heat transfer member between the plurality of battery cells 100. The heat transfer member may have characteristics including adhesive properties and thermal conductivity above a specified value. For example, the material of the heat transfer member may be a polymer material possessing thermal conductivity, such as an epoxy or urethane-based material.

The housing cover 220 can be coupled to the housing body 210. The housing cover 220 can form an inner surface of the receiving space when coupled to the housing body 210. The housing cover 220 can cover an opening 211 of the housing body 210. The housing cover 220 may contact or face at least a portion of the plurality of battery cells 100 in a third direction Z. For example, the housing cover 220 may contact or be placed on top of the upper surfaces of the plurality of battery cells 100. The housing cover 220 may cover at least a portion of the upper surfaces of the plurality of battery cells 100.

The housing cover 220 may overlap the busbar assembly 300 in a third direction Z. For example, the housing cover 220 may cover the top surface of the busbar assembly 300.

An end plate 230 may be connected to the housing body 210 and the housing cover 220 to form one side of the receiving space where the plurality of battery cells 100 are received. The end plate 230 may be positioned on one side of the plurality of battery cells 100. For example, the end plate 230 may abut or face the side of the plurality of battery cells 100 in a second direction Y. The end plate 230 may cover the side of the plurality of battery cells 100 in the second direction Y. The end plate 230 may be positioned between the plurality of battery cells 100 in the second direction Y. For example, an end plate 230 may be positioned at the front of the plurality of battery cells 100, and another end plate 230 may be positioned at the rear of the plurality of battery cells 100.

The end plate 230 may overlap at least a portion of the busbar assembly 300. For example, the end plate 230 may abut or face one side of the busbar assembly 300 in the second direction Y. The end plate 230 may cover one surface of the busbar assembly 300 in the second direction Y.

The busbar assembly 300 may electrically connect at least a portion of the plurality of battery cells 100.

The busbar assembly 300 may cover a plurality of battery cells 100 in the protruding direction of the tabs 112, 113. The busbar assembly 300 may be positioned on the outer side of the plurality of battery cells 100 in a second direction Y. The busbar assembly 300 may extend along a first direction X in which the plurality of battery cells 100 are stacked.

The busbar assembly 300 may include a busbar frame 310 and a busbar 320. The busbar 320 may be connected to the busbar frame 310. The busbar frame 310 may be positioned between the busbar 320 and the plurality of battery cells 100.

The tabs 112, 113 included in the battery cell 110 may penetrate the busbar frame 310. The busbar frame 310 may include a hole through which the tabs 112, 113 penetrate. For example, the busbar frame 310 may include a slit. The tabs 112, 113 may be inserted into the busbar 320 by passing through the busbar frame 310.

The busbar 320 may be formed in a plurality. The busbar 320 may be connected to the busbar frame 310 on a side of the busbar frame 310 not facing the plurality of battery cells 100. The tabs 112, 113 may be inserted into the busbar 320 to electrically connect the plurality of battery cells 100 and the busbar 320. The busbar 320 may include a hole into which the tabs 112, 113 are inserted. For example, the busbar 320 may include a slit.

FIG. 3 is a perspective view illustrating the battery cells and thermal barrier members of the battery assembly of FIG. 2.

Referring to FIG. 3, the tabs 112, 113 may protrude from the cell case 111 of the battery cell 110. For example, in a second direction Y, the tabs 112, 113 may protrude from the cell case 111. The tabs 112, 113 may be electrically connected to an electrode of the electrode assembly. Although FIG. 3 shows the tabs 112, 113 protruding in the second direction Y, the embodiments are not limited thereto. For example, the tabs 112, 113 may protrude from the cell case 111 in a first direction X. In another example, the tabs 112, 113 may protrude from the cell case 111 in a third direction Z.

The tabs 112, 113 may include a first electrode tab 112 and a second electrode tab 113. The first electrode tab 112 may be electrically connected to one of a negative electrode and a positive electrode of the electrode assembly, and the second electrode tab 113 may be electrically connected to the other of the negative electrode and the positive electrode.

In one embodiment, a thermal barrier member 400 may be disposed between at least some of the battery cells 110. The thermal barrier member 400 may be disposed between the battery cells 110 along the stacking direction or the first direction X of the battery cells 110. One side of the thermal barrier member 400 may be covered by the battery cell 110.

For example, the thermal barrier member 400 may include a fire-resistant material. For instance, the fire-resistant material may include mica, epoxy, silica, aerogel, ceramic wool, urethane, or a material with excellent heat resistance and thermal insulation properties.

The thermal barrier member 400 may protrude outward in the third direction Z relative to the battery cell 110. For example, the thermal barrier member 400 may protrude outward in the third direction Z toward the housing cover 220, referring to FIG. 2, relative to the battery cell 110. In the third direction Z, one end of the thermal barrier member 400 may protrude toward the housing cover 220 relative to one surface of the battery cell 110. In the third direction Z, one end of the thermal barrier member 400 may not be positioned in the same plane as one surface of the battery cell 110.

The thermal barrier member 400 may protrude outwardly beyond the battery cell 110 in the second direction Y. For example, the thermal barrier member 400 may protrude toward the end plate 230, referring to FIG. 2, relative to the battery cell 110 in the second direction Y. In the second direction Y, one end of the thermal barrier member 400 may protrude toward the end plate 230 relative to one surface of the battery cell 110. The thermal barrier member 400 may protrude toward the busbar 320, referring to FIG. 2, relative to the battery cell 110 in the second direction Y. In the second direction Y, one end of the thermal barrier member 400 may not be positioned in the same plane as one surface of the battery cell 110.

In the first direction X, the end of the thermal barrier member 400 may be positioned between the tabs 112, 113. In the first direction X, the end of the thermal barrier member 400 may be alternately positioned with the tabs 112, 113.

FIG. 3 illustrates two battery cells 110 being arranged between thermal barrier members 400, but the embodiments are not limited thereto. The number of battery cells 110 arranged between adjacent thermal barrier members 400 may vary depending on the specific embodiment.

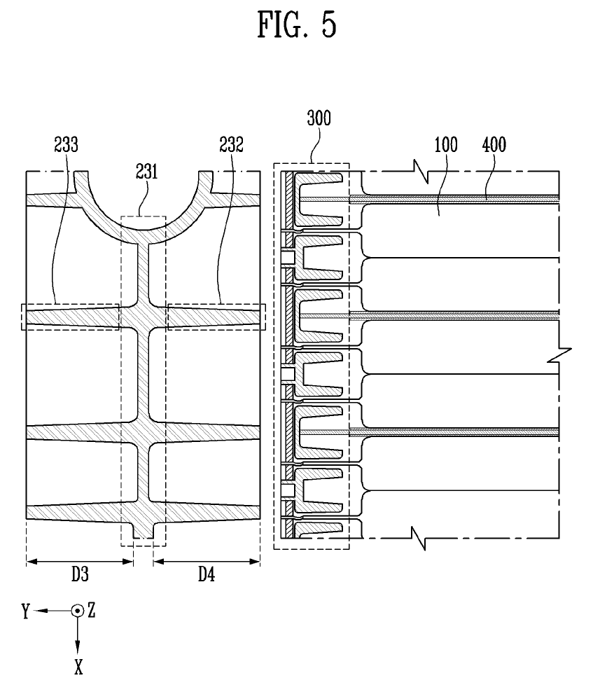

FIGS. 4 and 5 are drawings illustrating the end plate of the battery assembly shown in FIG. 2. In FIGS. 4 and 5, the structure of the end plate 230 is illustrated in detail. FIG. 4 is a perspective view showing a portion of the battery assembly 1 including the end plate 230. FIG. 5 is a view of a portion of the battery assembly 1 including the end plate 230 as seen in the third direction Z.

Referring to FIGS. 4 and 5, the battery assembly 1, referring to FIG. 2, may include battery cells 100, end plate 230, a busbar assembly 300, and thermal barrier members 400. Details overlapping with the description referring to FIGS. 1 through 3 are omitted hereafter.

The end plate 230 may be positioned adjacent to the tabs of the battery cells 100. The end plate 230 is positioned on the outer side of the battery cells 100 and extends along the stacking direction or the first direction X, and a first support wall 232 that protrudes from the support body 231 toward the battery cells 100 and partitions the space between the battery cells 100 and the support body 231.

The first support wall 232 may be provided in a plurality. The plurality of first support walls may be arranged at predetermined intervals along the stacking direction or the first direction X.

The busbar assembly 300 is positioned between the end plate 230 and the battery cells 100, and the first support wall 232 may contact the busbar assembly 300.

The end plate 230 may further include a second support wall 233 protruding away from the support body 231 in a direction away from the battery cells 100 or the second direction Y. The embodiment further including the second support wall 233 corresponds to a case where another battery assembly 1 is placed beside the battery assembly 1, i.e., where battery assemblies are placed on both sides relative to the end plate 230. In configurations where no other battery assembly 1 is adjacent, a form comprising only the first support wall 232 may be applied.

The second support wall 233 may be provided in a plurality. The plurality of second support walls may be arranged at predetermined intervals along the stacking direction or the first direction X.

The first support wall 232 and the second support wall 233 may be positioned correspondingly around the support body 231. When the first support wall 232 and the second support wall 233 are each provided in a plurality, the plurality of first support walls and the plurality of second support walls may be positioned corresponding to each other with respect to the support body 231.

The height of the first support wall 232 may be the first length D1. Similarly, the height of the second support wall 233 may be the first length D1. The height of each battery cell 100 may be the second length D2. The size of the first length D1 may be equal to or greater than the size of the second length D2. In other words, the height of the first support wall 232 may be equal to or greater than the height of the battery cells 100, and the height of the second support wall 233 may be equal to or greater than the height of the battery cells 100.

The first support wall 232 may protrude a fourth length D4 from the support body 231. The second support wall 233 may protrude a third length D3 from the support body 231. The fourth length D4 may be greater than the third length D3. In other words, the protrusion length of the first support wall 232 may be equal to or greater than the protrusion length of the second support wall 233. However, the embodiments of the present disclosure are not necessarily limited to this. For example, the protrusion length of the second support wall 233 may be equal to or greater than the protrusion length of the first support wall 232.

The first support wall 232 and the second support wall 233 may each tapered as they move away from the support body 231. However, the embodiments of the present disclosure are not necessarily limited to this. For example, the first support wall 232 and the second support wall 233 may each have a shape that is reverse tapered as they move away from the support body 231. For example, each of the first support wall 232 and the second support wall 233 may have a shape with a constant thickness in the first direction X, regardless of the distance from the support body 231.

The battery assembly 1, referring to FIG. 2, may have thermal barrier member 400 positioned between battery cells 100 along the stacking direction or the first direction X. The first support wall 232 may be positioned to correspond with the thermal barrier member 400 along the stacking direction or first direction X. In other words, the first support wall 232 may be located on the extension line of the thermal barrier member 400 in the second direction Y.

The first support wall 232 and the thermal barrier member 400 may each be provided in a plurality. A plurality of first support walls may be positioned in correspondence with a plurality of thermal barrier members along the stacking direction or the first direction X.

When the second support wall 233 is positioned in correspondence with the first support wall 232 and the support body 231 centered on each other, the second support wall 233 may be positioned in correspondence with the thermal barrier member 400 along the stacking direction or the first direction X. In other words, the second support wall 233 may be positioned on an extension line of the thermal barrier member 400 in the second direction Y.

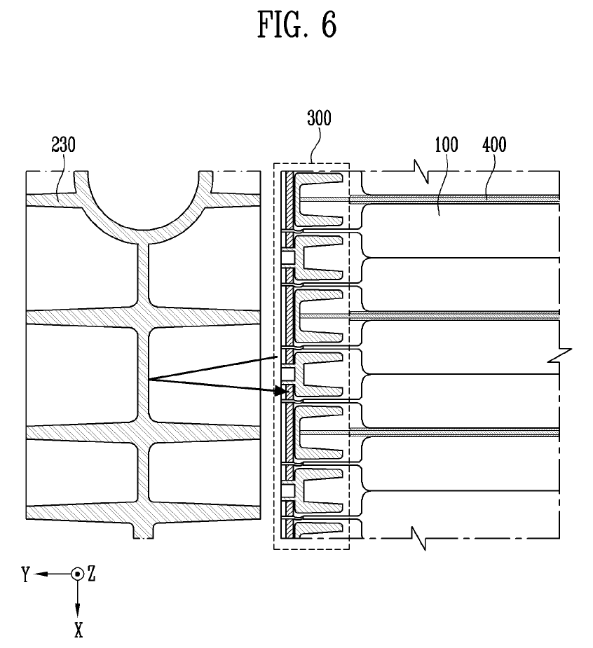

FIG. 6 is a drawing illustrating the effect based on the structure of the end plate in FIG. 2.

Referring to FIGS. 5 and 6, flame or smoke may unintentionally be emitted from any one of the battery cells 100.

If the end plate 230 does not include a first support wall 232, the flame or smoke may propagate to adjacent battery cells. Thermal propagation (TP) may degrade the battery life of the battery assembly 1.

On the other hand, the end plate 230 of the battery assembly 1 according to the present disclosure may include a first support wall 232. The flame or smoke is blocked by the support body 231 and the first support wall 232 and cannot propagate to adjacent battery cells (see arrow). Consequently, the thermal propagation is effectively blocked, potentially improving the battery life of the battery assembly 1.

FIG. 7 is an enlarged view of the X portion of FIG. 2.

Referring to FIGS. 2 and 7, the battery assembly 1 may include a housing body 210. One surface or the bottom surface of the housing body 210 may include groove 212 arranged at predetermined intervals along the stacking direction or first direction X of the battery cells 100. Depending on the embodiment, the groove 212 may be provided in a plurality.

A thermal barrier member 400 may be inserted into the groove 212.

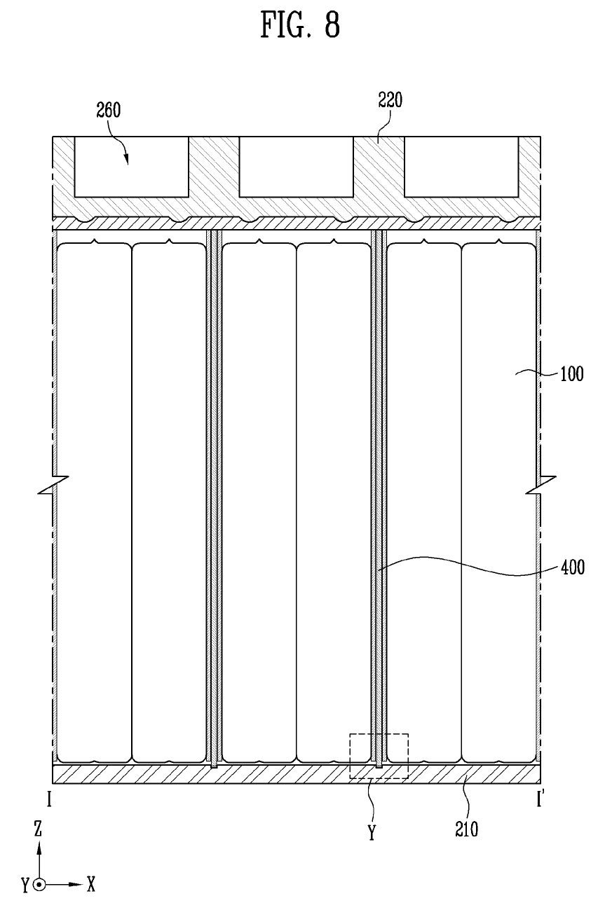

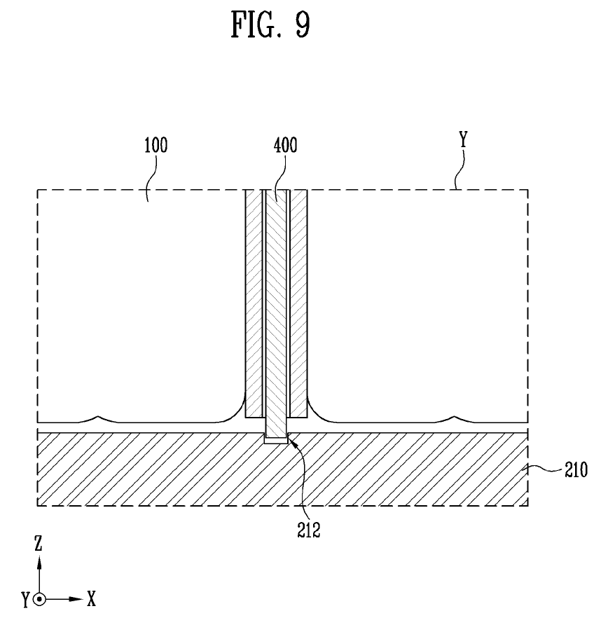

FIGS. 8 and 9 are drawings illustrating the effects of the structure of the housing body in FIG. 2. FIG. 8 is a drawing showing a cross-section along line I-I' of FIG. 1. FIG. 9 is an enlarged view of part Y of FIG. 8.

Referring to FIGS. 8 and 9, the battery assembly 1 may include battery cells 100, a housing body 210, a housing cover 220, and a thermal barrier member 400. The housing cover 220 may be combined with the housing body 210 to jointly form a receiving space for receiving the battery cells 100. The housing cover 220 may include a venting hole 260 penetrating the housing cover 220.

The venting hole 260 may be positioned between the thermal barrier members 400. The venting hole 260 may be provided in a plurality, and the plurality of venting holes 260 may be positioned between the thermal barrier members 400.

The thermal barrier member 400 may protrude toward the housing cover 220 relative to the battery cells 100. In other words, the thermal barrier member 400 may protrude in a third direction Z relative to the battery cells 100. The thermal barrier member 400 may contact the housing cover 220. Accordingly, between adjacent battery cells centered around the thermal barrier member 400, the movement of material near the housing cover 220 can be effectively blocked by the thermal barrier member 400. Furthermore, the propagation of flames or smoke emitted from any one of the battery cells 100 to adjacent battery cells during their escape through the venting hole 260 can be effectively blocked.

Referring to FIG. 9, the thermal barrier member 400 can be fitted into the groove 212. Centered around the thermal barrier member 400, the movement of substances near the housing body 210 can be effectively blocked between adjacent battery cells by the thermal barrier member 400. Furthermore, the propagation of flames or smoke emitted from any one of the battery cells 100 to adjacent battery cells can be effectively blocked.

As a result, the battery assembly 1 according to this disclosure, by including an end plate 230 and a groove 212, effectively blocks the propagation of flames or smoke generated from battery cells to adjacent battery cells and can guide such flames or smoke to be discharged through the venting hole 260.

The present disclosure may be practiced in various forms of modification and is not limited to the scope of the above-described embodiments. Therefore, if a modified embodiment includes the components of the claims of the present disclosure, it should be considered within the scope of the present disclosure.

What is claimed is:

1. A battery assembly comprising:
battery cells arranged along a stacking direction; and
a housing case receiving the battery cells and including an end plate positioned adjacent to tab portions of the battery cells;
wherein the end plate comprises: a support body positioned outside the battery cells and extending along the stacking direction; and a first support wall protruding from a surface of the support body toward the battery cells and partitioning a space between the battery cells and the support body.

2. The battery assembly according to claim 1, further comprising:
a busbar assembly positioned between the end plate and the battery cells and electrically connecting the battery cells,
wherein the first support wall contacts the busbar assembly.

3. The battery assembly according to claim 1, wherein the first support wall is provided in a plurality, and
wherein the plurality of first support walls are arranged at predetermined intervals along the stacking direction.

4. The battery assembly according to claim 1, wherein the end plate further includes a second support wall protruding from another surface of the support body in a direction away from the battery cells.

5. The battery assembly according to claim 4, wherein the first support wall and the second support wall are positioned correspondingly with respect to the support body.

6. The battery assembly according to claim 5, wherein the first support wall and the second support wall are each provided in a plurality, and the plurality of first support walls and the plurality of second support walls are positioned corresponding to each other with respect to the support body.

7. The battery assembly according to claim 4, wherein a protrusion length of the first support wall is equal to or greater than a protrusion length of the second support wall.

8. The battery assembly according to claim 4, wherein the first support wall and the second support wall are each tapered as they move away from the support body.

9. The battery assembly according to claim 4, wherein a height of the first support wall is equal to or greater than a height of the battery cells.

10. The battery assembly according to claim 4, wherein a height of the second support wall is equal to or greater than a height of the battery cells.

11. The battery assembly according to claim 1, further comprising:
a thermal barrier member disposed between the battery cells along the stacking direction,
wherein the first support wall is positioned in correspondence with the thermal barrier member along the stacking direction.

12. The battery assembly according to claim 11, wherein the first support wall and the thermal barrier member are each provided in a plurality, and the plurality of first support walls are positioned in correspondence with the plurality of thermal barrier members along the stacking direction.

13. The battery assembly according to claim 11, wherein the housing case includes a housing body forming a receiving space for receiving the battery cells, and the housing body includes grooves arranged at predetermined intervals along the stacking direction.

14. The battery assembly according to claim 13, wherein the thermal barrier is provided in a plurality, and each of the plurality of thermal barrier members is inserted into a corresponding one of the grooves.

15. The battery assembly according to claim 13, wherein the housing case includes a housing cover coupled to the housing body to form the receiving space together, and the housing cover includes a venting hole penetrating the housing cover.

16. The battery assembly according to claim 15, wherein the venting hole and the thermal barrier are provided in a plurality, wherein each of the plurality of venting holes is located between each of the plurality of thermal barrier members.

17. The battery assembly according to claim 15, wherein the thermal barrier member protrudes toward the housing cover beyond the battery cells.

18. The battery assembly according to claim 17, wherein the thermal barrier member contacts the housing cover.

19. A battery assembly comprising:
battery cells each including an electrode assembly, a cell case accommodating the electrode assembly, and a tab protruding from the cell case and electrically connected to the electrode assembly;
a housing case forming a receiving space for receiving the battery cells arranged along a predetermined stacking direction, and including an opening formed between the battery cells along a direction in which the tab protrudes; and
an end plate coupled to the housing case and covering the opening;
wherein the end plate partitions the receiving space between the battery cells.
